(19) United States
(12) Patent Application Publication
(10) Pub. No.: US 2013/0187507 A1
(43) Pub. Date: Jul. 25, 2013

(54) ROTOR COMPRISING ADDED POLE SHOES COVERING THE MAGNETS AND A ROTARY ELECTRIC MACHINE

(71) Applicants: Colas Fouquart, Saint Jean De Braye (FR); Yannick Messin, Ferolles (FR); Pierre Rigaud, Checy (FR); Thomas Verchere, Orleans (FR)

(72) Inventors: Colas Fouquart, Saint Jean De Braye (FR); Yannick Messin, Ferolles (FR); Pierre Rigaud, Checy (FR); Thomas Verchere, Orleans (FR)

(73) Assignee: MOTEURS LEROY-SOMER, ANGOULEME (FR)

(21) Appl. No.: 13/825,468

(22) PCT Filed: Oct. 4, 2011
(86) PCT No.: PCT/IB11/54365

§ 371 Date: Apr. 12, 2013

(30) Foreign Application Priority Data
Oct. 7, 2010 (FR) 1058141

(51) Int. Cl. H02K 1/28; H02K 1/27

(52) U.S. Cl. CPC H02K 1/28; H02K 1/274
USPC 310/156.15

(57) ABSTRACT

The present invention relates to a rotor for a rotary electric machine, comprising: a hub comprising a stack of sheets, permanent magnets arranged on the surface of the stack of sheets, pole shoes covering the magnets and an attachment means for holding the pole shoes on the hub.

The present invention relates to a rotor for a rotary electric machine, and a rotary electric machine comprising such a rotor.

Patent application JP-10-336929 discloses a rotor with permanent magnets in which the magnets are placed on parts forming a seat, themselves attached to a rotor body, the magnets being covered by fitted shoes. Attachment screws are engaged in the parts forming the seat and in the shoes.

Also known are rotors comprising buried magnets, which are inserted in housings of a stack of sheets. Magnetic losses occur, because a certain portion of the flux of the magnets travels between the poles of the magnets in the portions of sheet that extend around the housings.

The object of the invention is to further enhance the rotors of rotary electric machines by proposing, according to one of its aspects, a rotor, comprising:
a hub comprising a stack of sheets,
magnets arranged on the surface of the stack of sheets,
fitted pole shoes covering the magnets, and
attachment means for holding the pole shoes on the hub.

The attachment means may, in exemplary embodiments, be amagnetic.

The magnets are protected by the fitted pole shoes, but without having the drawback of magnetic leakage.

Reducing the magnetic leakage makes it possible to reduce the weight of magnets necessary and therefore to obtain a rotor that is cheaper to manufacture. The quantity of magnets may for example be reduced.

Moreover, in the invention, the magnets are placed directly on the surface of the hub, without use of parts forming a seat, which notably simplifies assembly.

The invention makes it possible to reduce the bulk of the machine for an equivalent power output.

The presence of the fitted pole shoes makes it possible to prevent certain losses, by eddy currents, notably in the case of machines with relatively high rotation speed, for example between 10 and 5000 rpm, for example between 800 and 2000 rpm.

Moreover, the attachment of the magnets to the stack of sheets is particularly stable. Specifically, the magnets are not only held by bonding, hooping or self-locking within the pack of sheets. The magnets according to the invention are preferably held neither by bonding, nor by hooping nor by self-locking. The magnets are preferably not bonded.

The machine according to the invention may advantageously generate a power of the order of several MW. The power generated may notably be between 10 kW and 20 MW.

The rotor according to the invention may be the result of an assembly method that is simple to apply and ensures good security during assembly.

It is possible for the rotor to have no winding because of the presence of the magnets.

The attachment means may pass through the magnets. The magnets may be pierced during assembly or, as a variant, be manufactured with appropriate holes.

The attachment means may comprise screws which are amagnetic or magnetic. The screws comprise screw heads which may rest in recesses arranged in the pole shoes, emerging on the radially outer surface of the latter. The screw heads may rest on washers. The screw heads may be set back from the radially outer surface of the pole shoes. As a variant, the screws are replaced by threaded studs and nuts.

The attachment means may be produced in an amagnetic material. In the case of a screw for example, the head and the body may be amagnetic. They may for example be made in an amagnetic material such as steel, for example an A480 chromium-nickel steel.

The attachment means may be engaged, during the assembly of the rotor, in the pole shoes via a radially outer side of the rotor. This may be advantageous if the rotor has a relatively low number of poles, for example less than 10 or 12 poles.

The attachment means may be engaged on magnetic bars inserted into the stack of sheets of the hub, extending over substantially the whole length of the hub. A bar may be in one piece or, as a variant, comprise several elements. The bars may be held in slide rails arranged in the stack of sheets. The slide rails may emerge on the radially outer surface of the pack of sheets of the hub, or they may not. In the latter case, the stack of sheets of the hub may comprise through-holes, emerging in the slide rail and allowing the passage of the attachment means during assembly. As a variant, the stack of sheets comprises longitudinal slots emerging at the outside on the circumference of the hub, the slots allowing the passage of the attachment means. The slide rails may have the shape of an inverted T or, as a variant, a trapezium shape for example.

It is possible to obtain the slide rails by using a single type of sheet for the hub. As a variant, two different types of sheets are used, which may be more costly, but makes it possible to obtain slide rails that do not emerge on the outer periphery of the hub, except at the location of the passageways for the attachment means. As a further variant, it is possible to use T-shaped or trapezium-shaped magnetic bars engaged in T-shaped or inverted trapezium-shaped slide rails in order to improve the conduction of the magnetic flux beneath the magnets.

At least one pole shoe may comprise a plurality of elements stacked along the rotation axis of the rotor and held together, preferably by at least one tie-rod, better at least two longitudinal tie-rods, or by at least one longitudinal weld. The number of tie-rods may be chosen according to the width of the pole.

At least one pole shoe may be laminated. It may consist of packs of magnetic sheets, insulated or not, for example varnished or anodized, obtained by punching or by laser cutting. This may make it possible to reduce the surface losses by eddy currents, notably to reduce the losses relative to shoes that might be solid, which improves the efficiency of the rotor and of the machine that comprises it.

As a variant, at least one pole shoe and/or at least one element of a pole shoe may be solid, being made for example by sintering of a magnetic powder.

In one embodiment, sheets are assembled to produce elements in the form of packs of sheets, then these elements are assembled to produce a pole shoe, which is then pierced to allow the passage of the attachment means. Recesses may be machined for housing a portion of the attachment means, such as screw heads. The elements forming the pole shoe may be assembled on an assembly bench comprising for example a cradle on which the elements can be placed.

The rotor may comprise, at each pole, amagnetic lateral plates, for protecting the magnets, placed between the stack of sheets of the hub and each pole shoe. The lateral plates are for example oriented parallel to a median radius passing through the rotation axis, and made from an electrically conductive amagnetic material such as aluminum.

Each pole may comprise at least two lateral plates or series of lateral plates placed end to end on either side of the magnets. Each pole may also comprise a plate or a series of intermediate plates placed between two magnets or two rows of magnets extending side by side.

“Series of plates” means a plurality of plates placed end-to-end in succession along the longitudinal axis of the rotor. A series of plates may be replaced by a single plate the length of which is substantially equivalent to the total of the lengths of the plates of the series, the lengths being measured along the longitudinal axis of the rotor.

The lateral and/or intermediate plates are preferably engaged in slide rails formed between the stack of sheets of the hub and the pole shoes.

Accordingly, the stack of sheets of the hub may comprise reliefs making it possible to guide first longitudinal edges of the plates. The pole shoes may comprise longitudinal reliefs making it possible to guide second longitudinal edges of the plates, opposite to the first longitudinal edges.

The stack of sheets of the hub may comprise longitudinal channels arranged between the poles, for example having a profile that narrows toward the circumference. These channels may allow the positioning of a tool, for example a jack, used to hold the pole shoe away from the hub during the insertion of the magnets between them and to lower the pole shoe onto the magnets after the magnets have been put in place.

As a variant, the hub may have no such channels, the insertion of the magnets being carried out in another manner.

The pole shoes may comprise lateral reliefs extending along the longitudinal axis of the rotor, for example lateral grooves. These reliefs may be used to hold the pole shoes on the aforementioned assembly bench. The latter may comprise clamping flanges which may be inserted into the lateral grooves.

The reliefs that are present laterally on the pole shoe may also be used to hold the pole shoe during its assembly to the rotor hub, by mean of the aforementioned jacks.

As a variant, the pole shoes may have no lateral reliefs, notably lateral grooves. The assembly on the hub may then be carried out in another manner.

A further subject of the invention is a method for manufacturing a rotor, in which a pole shoe is manufactured on an assembly bench, and then the pole shoe thus manufactured is placed on a hub of the rotor while arranging a gap designed to receive the magnets. The insertion of the latter may be carried out by placing them on an insertion bench placed in line with the hub, then by pushing them from the insertion bench into the gap arranged between the pole shoe and the hub. Then, the shoe may be progressively lowered onto the magnets by virtue of the aforementioned jacks. The attachment means may then be tightened. The insertion bench is separate from the hub. The attachment of the insertion bench in line with the hub may be carried out with the aid of rivets previously attached to the hub. These rivets may or may not remain within the hub once the insertion bench is separated from the hub.

A further subject of the invention is a rotary electric machine comprising a stator and a rotor as described above. The stator may be of any type, for example with concentrated or distributed or yet other winding. The rotor may comprise between 2 and 300 poles. The invention may be particularly advantageous for a rotor having a large number of poles. As a variant, the rotor may comprise a small number of poles, for example less than 12 poles, or even less than 10 poles, for example 8 or 6 poles, or even only 4 poles.

The rotary electric machine may be a synchronous machine. It may for example be a motor such as a propulsion motor, a compressor motor, of a pump, or a generator such as a generator of a wind turbine, of a hydraulic turbine or of an electricity generating unit.

The machine may comprise at least one end plate, supporting at least one bearing for guiding the rotor shaft, comprising at least one hole, or several holes, allowing rails to be engaged and removed for guiding the rotor supporting the magnets when it is installed in the stator.

The hole or holes may be closed off by trap doors, for example of rectangular shape.

The hole or holes may be of polygonal, notably rectangular or square, section.

The holes are preferably four in number, but their number for example ranges from one to six. The holes may preferably be evenly distributed angularly about the rotation axis and placed at one and the same distance from this axis, being for example symmetrical with one another relative to the rotation axis. The rails are engaged on the hub of the rotor in the inter-polar spaces.

The center of each hole is preferably situated on a circle with a diameter equivalent to the distance from the air gap to the rotation axis, so that each hole is situated facing the air gap. The section of each hole is for example between 10 and 600 cm². The holes may coincide with passageways of the rotor. As a variant, the rail may be immobilized between two poles, notably for the small machines.

The stator may be cooled if necessary by a circulation system of a gaseous or liquid coolant in channels of the stator, notably as described in international application WO 2009/103924, the content of which is incorporated by reference.

A further subject of the invention is a rotary electric machine comprising a stator and a rotor comprising:
a hub comprising a stack of sheets,
magnets arranged on the stack of sheets,
fitted pole shoes covering the magnets, and
attachment means for holding the pole shoes on the hub,
   the machine also comprising at least one end plate comprising at least one hole, or even several holes, allowing the engagement and the removal of rails for guiding the rotor when the rotor is installed in the stator, notably holes as defined above.

Such a machine may have all or some of the features mentioned above, with respect to the first aspect of the invention.

A further subject of the invention is a method for manufacturing a rotary electric machine comprising a stator and a rotor as described above, in which:
guide rails are placed in the stator, the rails preferably being longer than the rotor, the rails being able to comprise PTFE skids making sliding easier, at least one and preferably two end plates being engaged on the rails, and
the rotor is made to slide along the guide rails.

The end plate or plates comprise at least one hole, or even several holes, allowing the rails to be passed through and removed. Once the end plates are assembled on the stator, the rotor is held along the rotation axis by virtue of the bearings supported by the end plates, and then the guide rails can be removed through the hole or holes of the end plate or plates concerned. One of the end plates is engaged on the rails before the rotor is supported by the end plates.

Since the method for manufacturing the machine is preferably fully mechanized, it is easier to control the positioning of the various parts and to ensure a better mechanical stability of the poles. The noise and the vibrations of the machine and the repeatability of the manufacturing method are thus better controlled, the application of the latter being simpler and more secure.

As a variant, the machine could be manufactured in another manner.

The invention will be better understood on reading the following detailed description of a nonlimiting exemplary embodiment of the invention and on examining the appended drawing in which:

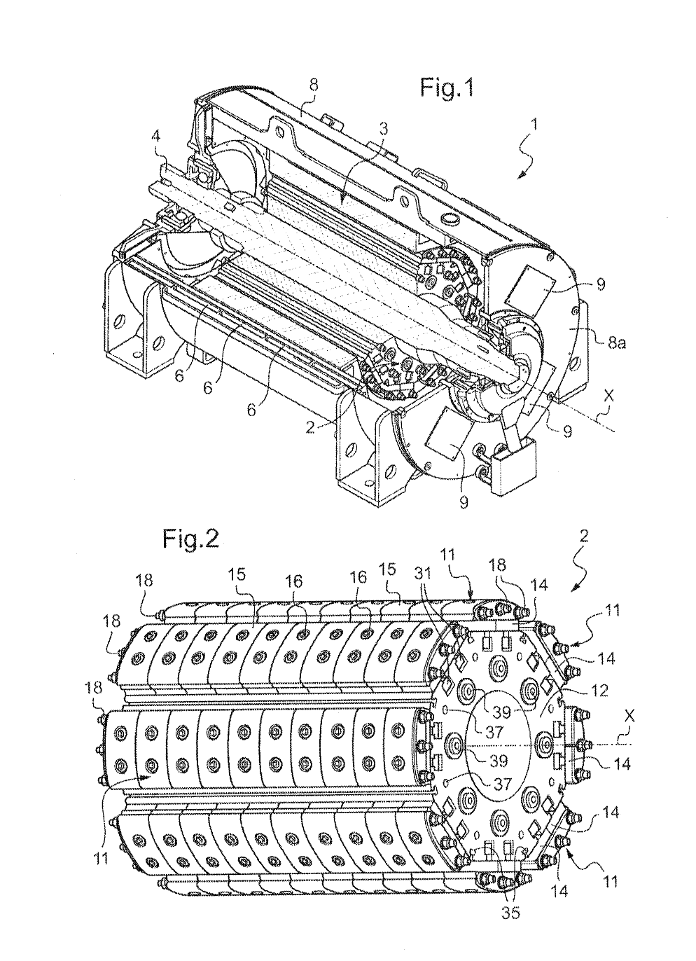

FIG. 1 is a view in perspective with cutaway of a rotary electric machine according to the invention,

FIG. 2 is a view in perspective of the rotor of FIG. 1,

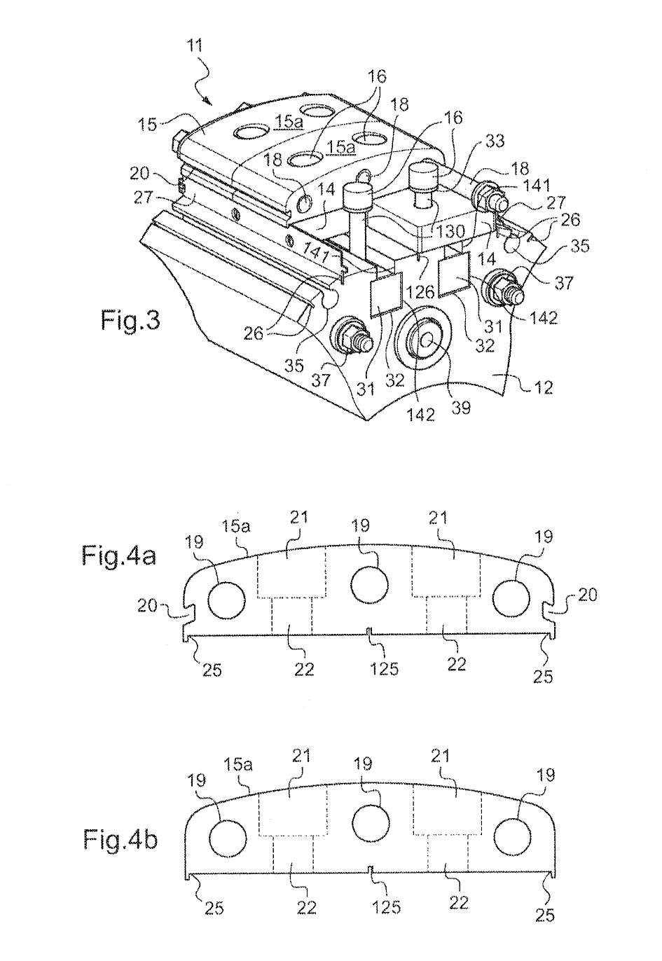

FIG. 3 is a schematic and partial view in perspective of a portion of the rotor of FIGS. 1 and 2,

FIGS. 4a and 4b are front views of elements forming a pole shoe,

FIG. 5 is a view in perspective illustrating the assembly of a pole shoe onto the rotor, and

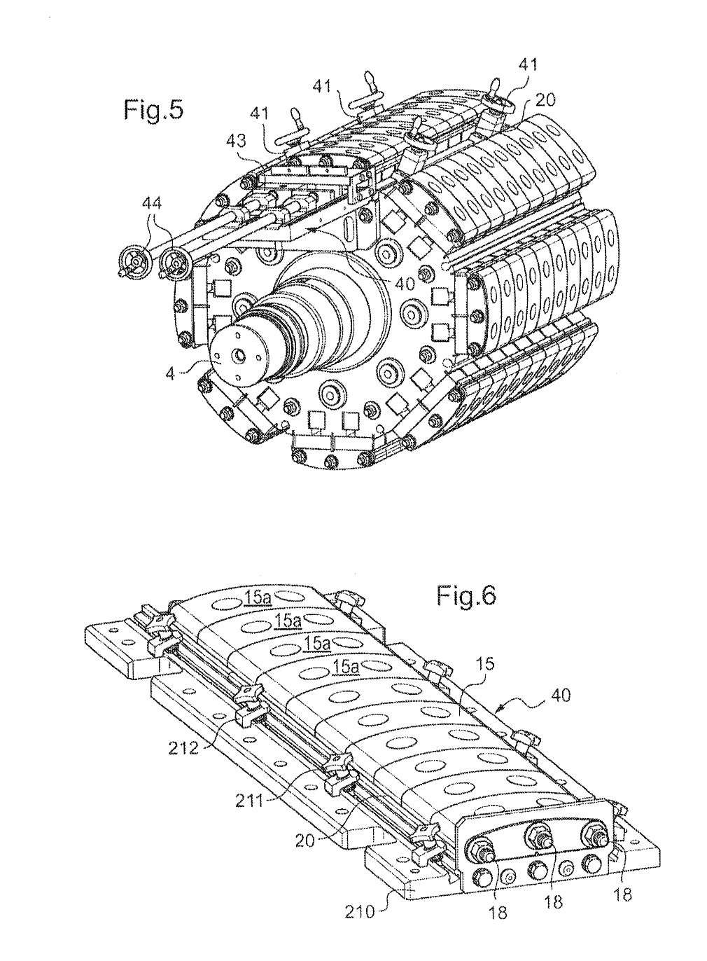

FIG. 6 is a schematic and partial view in perspective of the installation of a pole shoe.

Shown in FIG. 1 is a rotary electric machine 1 according to the invention comprising concentric rotor 2 and stator 3, the stator 3 being external and the rotor 2 internal, being mounted on a shaft 4 with its axis X.

The stator 3 comprises, in the example described, channels 6 in which a coolant, notably water, flows.

The machine 1 also comprises a casing 8 enclosing the stator and the rotor. The casing 8 comprises end plates 8a supporting the bearings of the rotor shaft comprising holes closed off by trap doors 9, the role of which will be explained below.

As a variant, the machine could be open, being cooled by a flow of air, then having no end plates.

The rotor 2 of the machine 1 will now be described in greater detail with reference to FIGS. 2 to 4.

In the example in question, the rotor 2 comprises eight poles 11 placed on a hub 12 comprising a stack of sheets. Each pole 11 comprises permanent magnets 14 mounted on the surface of the hub 12, and a fitted pole shoe 15 covering the magnets 14. Amagnetic attachment means 16 ensure the attachment of the pole shoes in the hub 12 on retaining bars 31.

In the example in question, each pole 11 comprises two rows of magnets 14 placed side by side. Each row of magnets comprises ten magnets 14 in succession along the rotation axis X so that each pole 11 comprises, in the example described, twenty magnets 14 in total. The NS axis of the magnets is substantially radial, the N and S poles alternating circumferentially.

Naturally, there is no departure from the context of the present invention if the situation is otherwise and if each pole 11 comprises a different number of magnets 14.

It is advantageous to use a relatively high number of magnets 14, because this makes it easier to manufacture the pole and to handle the magnets, the latter being relatively powerful.

The pole shoe 15 of a pole 11 comprises a succession of elements 15a along the axis X, numbering ten in the example described, this number being able to be different.

In the example described, the pole shoes 15 are laminated. Each element 15a may be formed by the assembly of sheets held together by clamps or other means. The elements 15a are kept stacked by tie-rods 18, numbering three for each pole shoe in the example in question, but this number may be different.

An element 15a is shown in FIG. 4a.

This figure shows the piercings 19 arranged in the sheets for the passage of the tie-rods 18.

The pole shoes 15 may comprise lateral grooves 20, of use when they are installed, as will be explained below, or on the contrary have no such grooves, as illustrated in FIG. 4b.

Each pole shoe 15 comprises passageways for the attachment means 16. In the example in question, the attachment means 16 are amagnetic screws comprising a head 21 and a stem 130, both being amagnetic. The pole shoes 15 comprise recesses 21 for receiving the screw heads and piercings 22 for the passage of the screw stems. The screw heads 21, once in place, are set back from the radially outer surface of the fitted pole shoe 15, as illustrated in FIG. 3.

The pole shoes 15 also comprise longitudinal ribs 25 forming, with corresponding longitudinal grooves 26 of the hub 12, slide rails designed to receive conductive lateral plates 27 extending between the hub 12 and the pole shoes 15 in order to laterally protect the magnets 14.

Each pole shoe 15 comprises a median groove 125 extending parallel to the axis X, and the hub 12 comprises, facing the latter, a corresponding groove 126, thus forming a slide rail for receiving one or more intermediate plates 127 that are not apparent in the drawing, placed between the two rows of magnets 14 of a pole.

The attachment means 16 are engaged with bars 31 inserted in slide rails 32 of the hub 12. The slide rails 32 are, in the example described, in the shape of an inverted T, with a longitudinal slot 141 emerging on an enlarged chamber 142 formed inside the hub 12. The bars 31 have a square or rectangular cross section. The stems 130 of the screws 21 pass through the slot 141 and are screwed into threads of the bars 31. Washers 33 placed under the screw heads improve the distribution of the force.

The magnets 14 are preferably placed directly on the radially outer surface of the hub 12, without the use of an intermediate part forming a seat.

The magnetic sheets forming the hub 12 that can be punched or cut by laser. This may generate certain irregularities on the surface of the stack of sheets of the hub. In order to remedy these irregularities, it is possible to mill the surface of the stack of sheets forming the hub. As a variant, it is possible to place between the stack of sheets and the magnets a sheet of a mechanically protective material which may optionally be electrically insulating, such as Nomex™.

The hub 12 comprises longitudinal channels 35 designed to receive jack feet, and rivets 37 for the attachment of an insertion bench 40, as will be described below.

The sheets of the stack forming the hub 12 are held together by rivets 39. As a variant, they could be hooped directly onto the shaft of the machine.

The method for manufacturing a rotor 2 will now be described in detail.

The hub 12 is manufactured. In a first step of the manufacture of the hub 12, the varnished magnetic sheets are stacked so as to produce the stack of sheets forming the hub. The sheets are pressed together before they are attached by rivets 39.

The stack of sheets is installed on the shaft 4 of the machine.

Independently of these steps for manufacturing the hub 12, the pole shoes 15 are manufactured.

In order to do this, the elements 15a are assembled on an installation bench 40, as illustrated in FIG. 6. Each element 15a consists of a stack of varnished magnetic sheets. The shoe 15 may for example comprise between 1 and 20 elements 15a, notably between 2 and 15.

After assembly of the elements 15a, they are attached by means of tie-rods 18 or longitudinal welds. The value of using tie-rods 18 is that it provides better control of the pressure of assembly of the sheets.

In a subsequent step, the recesses 21 and the piercings 22 designed to receive the attachment means 16, for example numbering twenty for a shoe designed to be attached by means of twenty screws to the hub, are produced in the shoe 15 that has just been assembled.

Each element 15a is pressed against the cradle 210 of the assembly bench 40 by tightening screws 211 which act on tightening clamps 212 engaged in the grooves 20.

Finally, each pole shoe 15 is put in place on the hub 12 while supporting it with the aid of the jacks 41, the feet of which are engaged in the longitudinal channels 35 and the heads of which are engaged in the lateral grooves 20, as illustrated in FIG. 5 and an insertion bench 340 is installed on the hub 12 by attaching it thereto with the rivets 37.

The jacks 41 are screw jacks in the example illustrated, operated by handles.

The plates 27 and 127 are placed between the hub 12 and the pole shoes 15 before the magnets are put in place and before each pole shoe 15 is lowered onto the magnets 14. These plates make it possible to attenuate the circulation currents, protect and improve the guidance of the magnets when each pole comprises two adjacent rows of magnets, with magnets placed side by side repelling one another.

Finally, the plates 27 and 127 guide the installation of the pole shoes 15.

The intermediate plate or plates 127 may or may not be removed at the end of the assembly. If they are removed, they free up a space which makes it possible to improve the circulation of air in the rotor.

The magnets 14 are inserted one by one between the hub 12 and the pole shoes 15, and between the lateral plates 27, by directing them by means of a pusher 43 movable by means of an associated handle 44. In the example illustrated, the insertion bench 340 comprises two pushers 43 and two associated handles 44 in order to put in place the two adjacent rows of magnets.

Putting the magnets 14 in place may be awkward. Specifically, for a rotor that is 1 m long, the back force due to the magnets may be of the order of 3 tons. The insertion bench 340 makes it possible to insert the magnets 14 and to bring them to their place in a simple, easy and reliable manner. It can be useful in correctly aligning the stack of sheets of the rotor and the pole shoes 15. Accordingly, the bottom of the insertion bench 340 may be placed in abutment on the hub 12.

The magnets 14 are placed in a housing of the insertion bench 340 which comprises an abutment so as to prevent the magnets from escaping. Then the magnet enters the gap between the hub and the pole shoe and is pressed by magnetic attraction to the hub. The insertion bench 340 may comprise a window that is smaller than the gap receiving the magnet in order to allow easier centering of the magnets in their housing.

The magnets can be put in place without lubricant or with lubricant.

Finally, using the attachment means 16, the pole shoe 15 and the magnets 14 are preassembled to the hub. The pole shoes 15 are then lowered onto the magnets 14 by operating the jacks 41 and the attachment means 16 are tightened.

It is not necessary to impregnate the rotor, which may be advantageous because of the operating temperature of the machine.

The rivets 37 allowing the installation of the insertion bench may or may not be removed. If they are left in place, they help to retain the rotor.

Finally, in a last step, the rotor 2 is installed in the stator 3. To do this, guide rails are placed in the stator, the rails preferably being longer than the rotor, and the rails being able to comprise PTFE skids making the sliding easier. The rotor is inserted in a centered manner into the stator by making it slide along the guide rails.

The end plates 8a supporting the bearings of the shaft are engaged in the rails.

The end plates 8a are assembled to the stator. Each end plate 8a comprises holes allowing the rails to pass through. It is then possible to remove the guide rails by virtue of the end-plate holes and then close the holes with the trap doors 9.

The invention is not limited to the examples that have just been described.

The rotor may notably comprise a different number of poles.

The expression “comprising one” is synonymous with “comprising at least one”, unless the contrary is specified.

1-13. (canceled)

14. A rotor for an electric rotary machine, comprising:
a hub comprising a stack of sheets,
permanent magnets arranged on the surface of the stack of sheets,
pole shoes covering the magnets, and
attachment means for holding the fitted pole shoes on the hub.

15. The rotor as claimed in claim 14, the attachment means passing through the magnets.

16. The rotor as claimed in claim 14, the attachment means being amagnetic.

17. The rotor as claimed in claim 16, the attachment means being amagnetic comprising amagneric screws.

18. The rotor as claimed in claim 17, the screws comprising heads set back from the radially outer surface of the pole shoes.

19. The rotor as claimed in claim 14, the attachment means being engaged in the pole shoes via a radially outer side of the rotor.

20. The rotor as claimed in claim 14, the amagnetic attachment means being engaged on bars inserted into the stack of sheets of the hub.

21. The rotor as claimed in claim 20, the bars being held in slide rails arranged in the stack of sheets of the hub.

22. The rotor as claimed in claim 14, at least one pole shoe comprising a plurality of elements stacked along the rotation axis (X) and held together.

23. The rotor as claimed in claim 22, at least one pole shoe comprising a plurality of elements stacked along the rotation axis (x) and held together by tie-rods.

24. The rotor as claimed in claim 14, comprising lateral plates for protecting the magnets, placed between the stack of sheets of the hub and the pole shoes.

25. The rotor as claimed in claim 24, the plates being engaged in slide rails formed between the stack of sheets of the hub and the pole shoes.

26. The rotor as claimed in claim 14, the pole shoes comprising lateral grooves.

27. The rotor as claimed in claim 14, the stack of sheets comprising longitudinal channels arranged between the poles.

28. A rotary electric machine comprising a stator and a rotor as claimed in claim 14.

29. The machine as claimed in claim 28, comprising at least one end plate comprising at least one hole closed by a trap door.

30. The machine as claimed in claim 28, comprising at least one end plate comprising several holes, closed by a trap door.

31. A rotor for an electric rotary machine, comprising:
a hub comprising a stack of sheets,
permanent magnets arranged on the surface of the stack of sheets,
fitted pole shoes covering the magnets and being held on the hub.
